(19) United States
(12) Patent Application Publication
(10) Pub. No.: US 2021/0195385 A1
(43) Pub. Date: Jun. 24, 2021

(54) TEXT MESSAGE DELIVERY BASED ON SPOKEN ANNOUNCEMENTS

(71) Applicants: Venkata Ratna Muddi, Bangalore Karnataka (IN); Sofeiyakalaimathy Covindane, Bangalore Karnataka (IN); Mukesh Kumar, Banglaore Karnataka (IN); Nandish Kopri, Blue Bell, PA (US); Kelsey L Bruso, Eagan, MN (US)

(72) Inventors: Venkata Ratna Muddi, Bangalore Karnataka (IN); Sofeiyakalaimathy Covindane, Bangalore Karnataka (IN); Mukesh Kumar, Banglaore Karnataka (IN); Nandish Kopri, Blue Bell, PA (US); Kelsey L Bruso, Eagan, MN (US)

(73) Assignee: Unisys Corporation, Blue Bell, PA (US)

(21) Appl. No.: 16/723,348

(22) Filed: Dec. 20, 2019

(51) Int. Cl. H04W 4/14; G06F 16/11; G06F 40/58; G10L 15/22; G10L 15/18; H04W 4/42; H04W 4/06

(52) U.S. Cl. CPC H04W 4/14; G06F 16/116; G06F 40/58; H04W 4/06; G10L 15/1815; H04W 4/42; G10L 15/22

(57) ABSTRACT

A method and system for delivering announcement broadcasts. The method includes receiving an announcement broadcast from a broadcast system of a transportation station. The method also includes interpreting the received announcement broadcast using natural language processing to extract transportation information. The method also includes the received announcement broadcast and the extracted transportation information in a data storage location. The method also includes translating the stored announcement broadcast into a text message. The method also includes transmitting the text message to at least one mobile device of at least one user registered with the announcement broadcast delivery method, based on the transportation information and the user information stored in the data storage location.

### BACKGROUND

### Field

The instant disclosure relates generally to annunciators, and in particular to annunciator methods and systems for delivering spoken announcements.

### Description of the Related Art

Passengers and other individuals listening to public announcements in crowded transportation stations (e.g., train stations, bus stations, airports or other public locations) often cannot understand the content and meaning of the announcement due to a variety of factors. Such factors include general background noise, muffled speech from the announcement speaker and the announcement being spoken in a language the listener does not understand.

There is a need for a method and system for translating a public spoken announcement into text, using natural language processing to interpret the text and extract transportation information from the test, translating the text to a chosen language(s) of a registered user/listener, and delivering the translated text to a mobile device of the registered user/listener, e.g., via SMS (short message service) or other suitable mobile-based delivery application.

### SUMMARY

Disclosed is a method and system for delivering announcement broadcasts. The method includes receiving an announcement broadcast from a broadcast system of a transportation station. The method also includes interpreting the received announcement broadcast using natural language processing to extract transportation information. The method also includes storing the received announcement broadcast and the extracted transportation information in a data storage location. The method also includes translating the stored announcement broadcast into a text message. The method also includes transmitting the text message to at least one mobile device of at least one user registered with the announcement broadcast delivery method, based on the transportation information and the user information stored in the data storage location.

### BRIEF DESCRIPTION OF THE DRAWINGS

FIG. 1 is a schematic view of the annunciator system communication architecture, according to an embodiment;

FIG. 2 is a schematic view of the processing flow of the annunciator system of FIG. 1, according to an embodiment;

FIG. 3 is a schematic view of an alternative processing flow of the annunciator system of FIG. 1, according to an embodiment;

FIG. 4 is a schematic view of data creation and storage associated with the annunciator system of FIG. 1, according to an embodiment;

FIG. 5 is a state-transition diagram for registering a user/listener of the annunciator system of FIG. 1, according to an embodiment;

FIG. 6 is a flow diagram of a method for registering a user/listener of the annunciator system of FIG. 1, according to an embodiment;

FIG. 7 is a flow diagram of a method for a user/listener of the annunciator system of FIG. 1 sending an SMS message to the annunciator system, according to an embodiment;

FIG. 8 is a flow diagram of a method for a user/listener obtaining and executing components of the annunciator system of FIG. 1, according to an embodiment;

FIG. 9 is a flow diagram of a method for a user/listener reading an announcement delivered by the annunciator system of FIG. 1, according to an embodiment;

FIG. 10 is a flow diagram of a method for a user/listener monitoring an announcement delivered by the annunciator system of FIG. 1, according to an embodiment;

FIG. 11 is a flow diagram of a method for processing announcement stores in the annunciator system of FIG. 1, according to an embodiment;

FIG. 12 is a flow diagram of a method for cleaning up an announcement delivered by the annunciator system of FIG. 1 within the method of FIG. 11, according to an embodiment;

FIG. 13 is a flow diagram of a method for cleaning up an announcement processed by the annunciator system of FIG. 1 within the method of FIG. 11, according to an embodiment;

FIG. 14 is a flow diagram of a method for cleaning up announcement data within the method of FIG. 11, according to an embodiment; and

FIG. 15 is a schematic view of an annunciator system, according to an embodiment.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting, and merely set forth some of the many possible embodiments for the claimed invention.

According to an embodiment, an annunciator method and system is provided to translate a spoken announcement into text, translate the text to a chosen language of a registered user/listener, and transmit or deliver the text to a mobile device of the registered user/listener via SMS (short message service) or other suitable mobile-based delivery application. In some embodiments, the announcement speaker reads from a prepared text. In such cases, the annunciator method and system receives the text file directly, bypassing speech to text conversion.

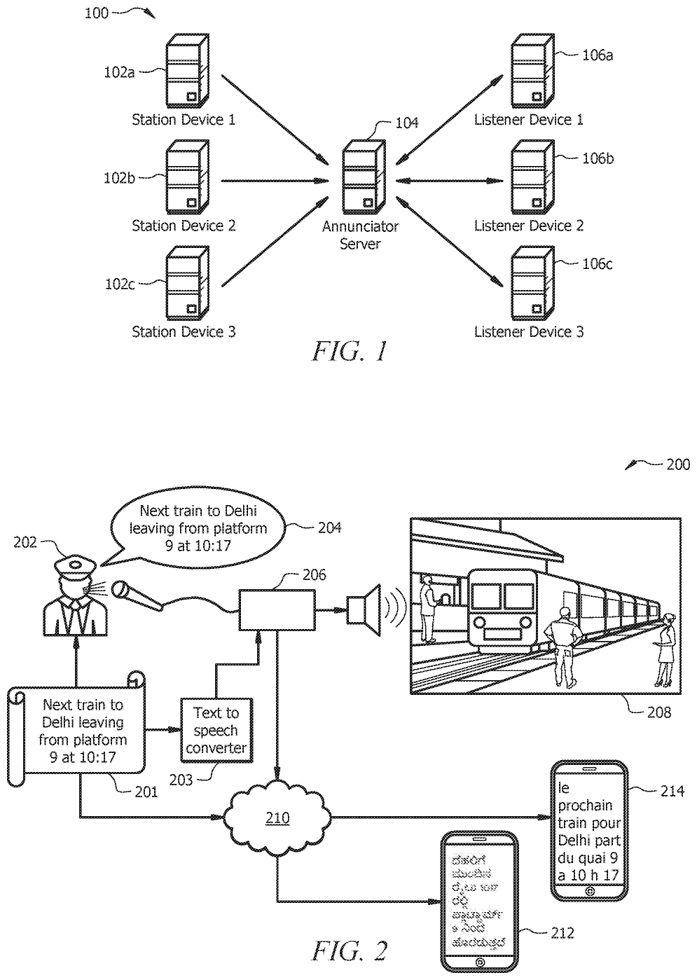

FIG. 1 is a schematic view of the annunciator system communication architecture 100, according to an embodiment. The annunciator system 100 includes a plurality of participant transportation station (e.g., train station, bus station or airport) devices 102a, 102b, 102c. The transportation station devices 102a, 102b, 102c are devices that make announcement broadcasts within the respective transportation station. The annunciator system 100 also includes an annunciator server 104, which receives announcement broadcasts from the participant transportation station devices 102a, 102b, 102c, e.g., in the form of audio files or text files. The annunciator system 100 also includes a plurality of registered user/listener devices 106a, 106b, 106c. Each registered user/listener device 106a, 106b, 106c receives from the annunciator server 104 the text of an announcement broadcast, which is translated into a chosen language of the registered user/listener.

FIG. 2 is a schematic view of the processing flow 200 of the annunciator system 100, according to an embodiment. An announcer 202 at the transportation station 208 makes an announcement broadcast 204, e.g., using an illustrative scripted text 201 or speaking extemporaneously. The announcement broadcast 204 is made using an announcement broadcast system or mechanism 206, and the announcement broadcast 204 is heard by users/listeners in the transportation station 208. Alternatively, the announcement broadcast system or mechanism 206 uses an automated text to speech converter 203 to convert the scripted text 201 into speech and to broadcast the converted announcement broadcast 204 using the announcement broadcast system or mechanism 206.

According to an embodiment, an annunciator system 210 receives the announcement broadcast 204 as a text file (e.g., the scripted text 201) or as an audio file (e.g., from the announcement broadcast system 206). The annunciator system 210 translates the audio file to text (if required), translates the text to a chosen language of each active registered user/listener, and sends the translated text to a mobile device 212, 214 of each active registered user/listener.

According to an embodiment, the annunciator system 210 executes the reception, translation and transmission of the announcement broadcast 204 “in the cloud.” According to another embodiment, the annunciator system 210 executes the reception, translation and transmission of the announcement broadcast 204 using one or more servers, e.g., servers owned by the transportation station 208.

According to an embodiment, the mobile device 212, 214 of each active registered user/listener is a “feature phone” supporting text message (SMS) capability. Alternatively, the mobile device 212, 214 of each active registered user/listener is a “smart phone” with standard or alternate messaging capability, such as WhatsApp, WeChat, or Facebook Messenger. Alternatively, the mobile device 212, 214 of each active registered user/listener executes an application (app) dedicated to the capabilities of the annunciator system 210.

The processing flow 200 of the annunciator system 210 illustrates the translation of the announcement broadcast 204 to a language different from the language of the announcer 202. However, it should be understood that the functions and capabilities of the annunciator system 210 applies equally to processing an announcement broadcast 204 in the same language, e.g., to assist active registered listeners who are hearing impaired.

According to an embodiment shown in FIG. 2, the annunciator system 210 involves announcement broadcasts at a single transportation station. According to alternative embodiment, the annunciator system 210 involves announcement broadcasts at multiple transportation stations.

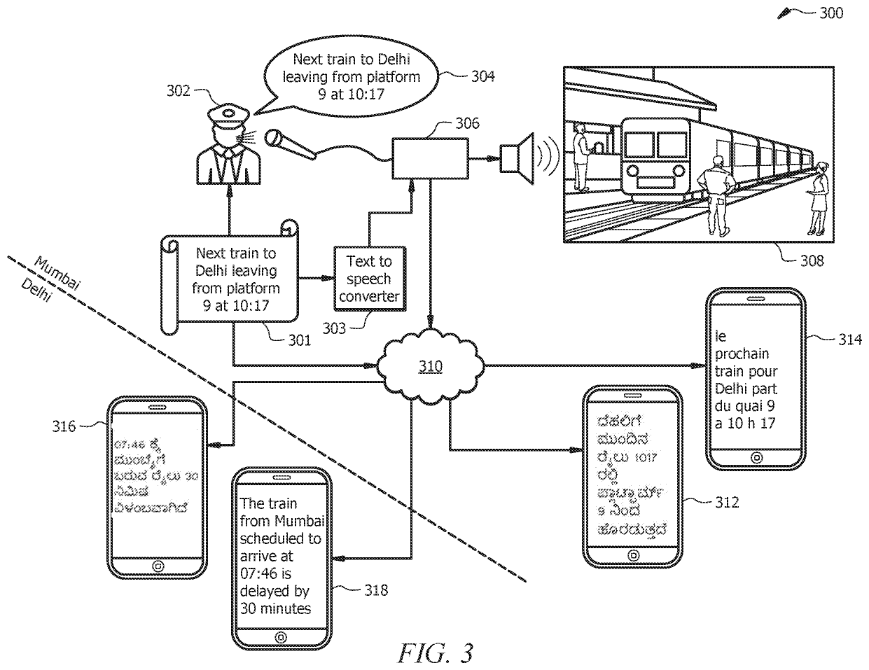

FIG. 3 is a schematic view of an alternative processing flow 300 of the annunciator system 100 of FIG. 1, according to an embodiment. As shown, an announcement broadcast 304 at a first transportation station (e.g., Mumbai) can be delivered to active registered user/listeners at a second transportation station (e.g., Delhi). In the alternative processing flow 300 of the annunciator system 310, the mobile devices 316, 318 are at a location (e.g., Delhi) different from the location where the announcement broadcast 304 is being made (e.g., Mumbai).

Using natural language processing, the annunciator system 310 reorients the text of the announcement broadcast 304 from the location where the announcement broadcast 304 was made (e.g., Mumbai) to the location of the mobile devices 316, 318 of the active registered listeners 316, 318 (e.g., Delhi). Also, among other modifications to the text of the announcement broadcast 304, the annunciator system 310 replaces “to Delhi” with “from Mumbai” and replaces “scheduled to depart at 10:17” with “scheduled to arrive at 7:46”. The text of other announcement broadcasts 304 have other appropriate replacements made by the annunciator system 310 to reorient the text of the announcement broadcast 304 to the location of each active registered user/listener. However, other processing flows in FIG. 3 retain the same processing roles as the processing flows in FIG. 2.

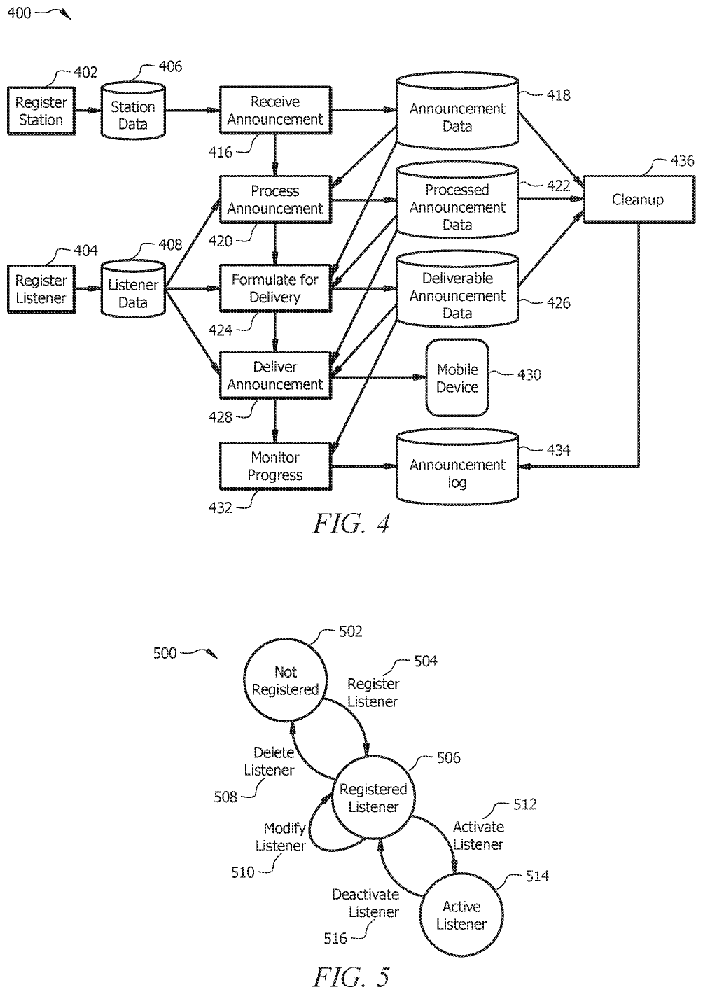

FIG. 4 is a schematic view of a data creation and storage method 400 associated with the annunciator system 100 of FIG. 1, according to an embodiment. FIG. 4 illustrates how to create and use the persistent and transient data stores during the operation of the annunciator system 100.

The method 400 includes registering a transportation station 402 (e.g., a train station, bus station or airport) and storing the transportation station registration information in a station data persistent data storage location or component 406. The transportation station registration information includes any suitable data related to the particular transportation station, such as the name of the transportation station, the location of the transportation station, the identification number or code of the transportation station, and a default language for announcements made at the transportation station.

The method 400 also includes registering a user/listener 404 and storing the user/listener registration information in a user/listener data persistent data storage location or component 408. The user/listener data registration information includes any suitable data related to the particular user/listener, such as the name and password of the user/listener, a mobile device number of the user/listener to receive announcement broadcasts, transportation stations (including station departures and arrivals) about which the user/listener wishes to receive announcement broadcasts, and whether the registered user/listener is active or inactive.

The method 400 also includes a step 416 of receiving a new announcement broadcast, e.g., as a text file or an audio file, from a transportation station. The data creation and storage method 400 also includes converting the received announcement broadcast from speech to text and saving the converted text in an announcement broadcast data persistent data storage location or component 418. The announcement broadcast data includes any suitable data related to the particular announcement broadcast, such as transportation station identification, announcement broadcast identification, language identification, a timestamp for the announcement broadcast, and the text of the announcement broadcast.

The method 400 also includes a step 420 of processing each new announcement broadcast. For an announcement broadcast from the announcement broadcast data persistent data storage location 418, the processing step 420 searches the user/listener data persistent data storage location 408 to determine each active user/listener that is to receive the announcement broadcast. The processing step 420 also determines the chosen language of each active user/listener that is to receive the announcement broadcast, converts the announcement broadcast text to the chosen language of each active user/listener, and saves the translated text of the announcement broadcast in a processed announcement broadcast data persistent data storage location or component 422.

The method 400 also includes a step 424 of formulating each processed announcement broadcast for delivery, and saving the relevant information in a deliverable announcement broadcast data persistent data storage location or component 426. The formulating step 424 takes a new announcement broadcast from the announcement broadcast data persistent data storage location 418, and for each active user/listener from the user/listener data persistent data storage location 408 who requests announcement broadcasts from the particular transportation station mentioned in the announcement broadcast, selects the corresponding translated announcement broadcast from the processed announcement broadcast data persistent data storage location or component 422, and creates an corresponding entry in the deliverable announcement broadcast data persistent data storage location or component 426.

The method 400 also includes a step 428 of delivering, for each entry in the deliverable announcement broadcast data persistent data storage location or component 426, the translated announcement broadcast to a mobile device 430 of each active registered user/listener from the user/listener data persistent data storage location 408.

The method 400 also includes a step 432 of monitoring, for each entry in the deliverable announcement broadcast data persistent data storage location or component 426, the success or failure of the delivery of the announcement broadcast. When the delivery of an announcement broadcast is complete, the monitoring step 432 removes the announcement broadcast from the deliverable announcement broadcast data persistent data storage location or component 426, and creates an entry for the success or failure of the announcement broadcast in an announcement log 434.

The method 400 also includes a step 436 of cleaning up the announcement broadcast information/data stored in the announcement broadcast data persistent data storage location 418, the processed announcement broadcast data persistent data storage location or component 422 and the deliverable announcement broadcast data persistent data storage location or component 426 for each announcement broadcast that has been delivered to the mobile device 430 of the appropriate active user/listener.

FIG. 5 is a state-transition diagram 500 for registering a user/listener of the annunciator system of FIG. 1, according to an embodiment. A user/listener starts in a not registered state 502. A user/listener can then register (shown as 504) to become a registered user/listener 506. The registered user/listener can perform an action 508 to delete the registration. The registered user/listener also can perform an action 510 to modify various registration attributes.

The registered user/listener also can transition (shown as 512) to being an active user/listener 514. As discussed hereinabove, announcement broadcasts are delivered only to active users/listeners. An active user/listener can deactivate (shown as 516) their active user/listener status. Such deactivation results in the registered user/listener no longer receiving announcement broadcasts.

According to an embodiment, a registered user/listener transitions to being an active user/listener 514 when geo-positioning or other suitable location mechanism detects that the user/listener has entered a participating transportation station. Also, according to an embodiment, an active user/listener becomes deactivated from their active user/listener status when geo-positioning or other suitable location mechanism detects that the active user/listener has exited a participating transportation station. Alternatively, a registered user/listener transitions between being an active user/listener and an inactive user/listener at the direction of the registered user/listener, i.e., at will.

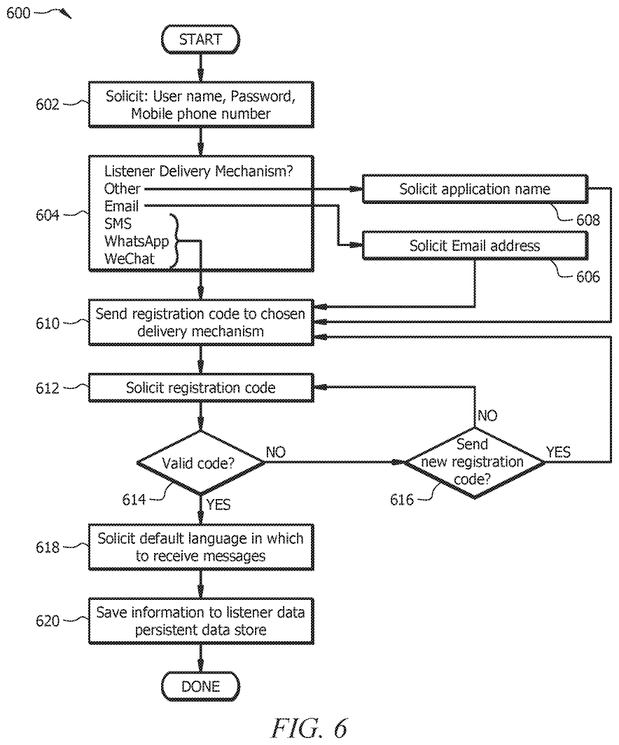

FIG. 6 is a flow diagram of a method 600 for registering a user/listener of the annunciator system of FIG. 1, according to an embodiment. The method 600 includes a step 602 of soliciting from the user/listener a set of identifying information, such as a username, a password and a mobile device phone number.

The method 600 also includes a step 604 of soliciting from the user/listener a desired or preferred delivery mechanism, such as email, SMS, WhatsApp, WeChat or other suitable delivery mechanism. One advantage of delivery via SMS is that SMS does not require an active Internet or data connection.

The method 600 also includes a step 606 of soliciting an email address if the user/listener chooses email as the preferred delivery mechanism. The method 600 also includes a step 608 of soliciting an application name if the user/listener chooses “Other” as the preferred delivery mechanism.

The method 600 also includes a step 610 of sending a registration code to the chosen delivery mechanism if the user/listener chooses SMS, WhatsApp or WeChat as the preferred delivery mechanism. The method 600 also includes a step 612 of soliciting from the user/listener the registration code that was just sent to the SMS, WhatsApp or WeChat delivery mechanism. The method 600 also includes a step 614 of validating the registration code.

If the registration code provided does not match the registration code sent (NO), the method 600 includes a step 616 of asking the user/listener for a next action, e.g., either re-enter the registration code (step 612) or send a new registration code (step 610). If the registration code provided matches the registration code sent (YES), the method 600 continues to a step 618 of soliciting from the user/listener a default language in which to receive announcement broadcasts. The method 600 also includes a step 620 of saving all user/listener registration information in the user/listener data persistent data storage location or component 408 (FIG. 4).

According to an embodiment, a user/listener chooses one delivery mechanism. Alternatively, a user/listener chooses a plurality of delivery mechanisms, in which case steps 604 through 620 repeat for each chosen delivery mechanism. Alternatively, a user/listener chooses a priority order for the delivery mechanism. Also, according to an embodiment, a different language in which to receive announcement broadcasts may be specified for each delivery mechanism.

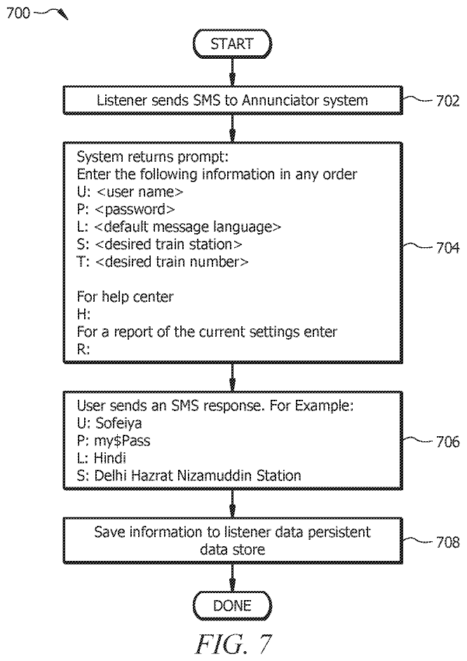

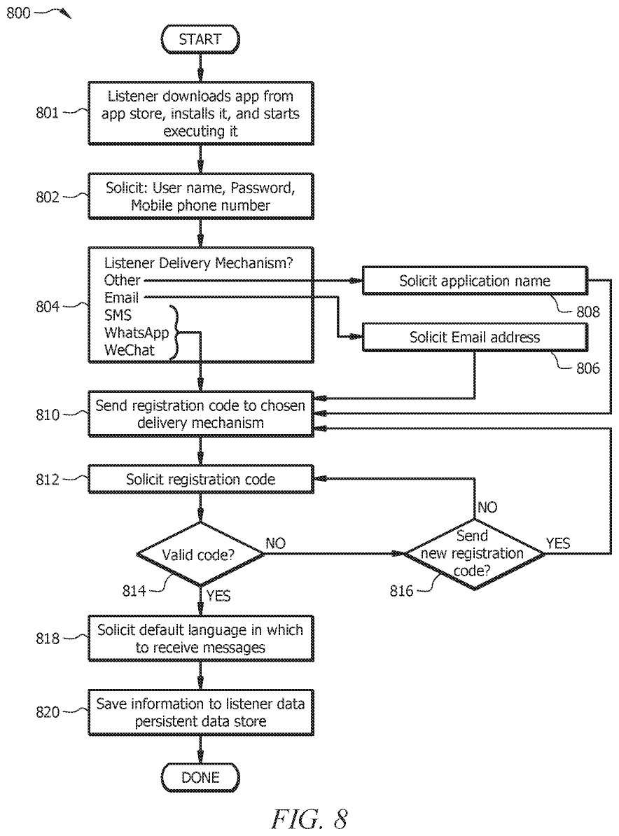

FIG. 7 is a flow diagram of a method 700 for a user/listener of the annunciator system of FIG. 1 sending an SMS message to the annunciator system, according to an embodiment. The method 700 includes a step of the user/listener sending an SMS message to the annunciator system. The method 700 also includes a step 704 of the annunciator system responding with a prompt to solicit information from the user/listener.

According to an embodiment, the prompt in the step 704 is a command line style interface that supports various commands. According to an alternative embodiment, the user/listener can specify the city and transportation station using an abbreviation.

With the command line style interface, the supported commands include user name (U:), password (P:), default message language (L:), desired transportation station (S:), and desired train, bus or airline number (T:). The supported commands also include a command to start receiving announcement broadcasts (START) and a command to stop receiving announcement broadcasts (STOP). The supported commands also include replacing the user name, password, default message language, desired transportation station, and desired bus, train or airline number (RU:, RP:, RL: RS:, RT:, respectively). The supported commands also include deleting the desired transportation station (DS:) and deleting the desired bus, train or airline number (DT:). The supported commands also include creating a report of all current settings and sending the report to the user/listener device (R:). The supported commands also include sending a HELP text, which explains all commands, to the user/listener device.

According to an embodiment, only a transportation station and a single train, bus or airline number are supported through the command line interface. According to an alternative embodiment, a plurality of transportation stations and a plurality of train, bus or airline numbers are supported through the command line interface.

The method 700 also includes a step 706 of the user/listener sending SMS responses to the annunciator system prompts. The method 700 also includes a step 708 of the annunciator system saving the sent SMS responses of the user/listener in the user/listener data persistent data storage location or component 408 (FIG. 4).

FIG. 8 is a flow diagram of a method 800 for a user/listener obtaining and executing components of the annunciator system of FIG. 1, according to an embodiment. For example, the user'/listener can access and use the annunciator system via a smart phone mobile device and an annunciator smart phone application (app).

The method 800 includes a step 801 in which a user/listener downloads and installs an annunciator smart phone application from an appropriate location onto a smart phone mobile device of the user/listener, and begins execution of the installed annunciator smart phone application. According to an embodiment, the following steps 802-820 (described hereinbelow) involving the interaction of the user/listener are driven by the annunciator smart phone application.

The method 800 also includes a step 802 of soliciting from the user/listener a set of identifying information, such as a usemame, a password and a mobile device phone number. The method 800 also includes a step 804 of soliciting from the user/listener a preferred delivery mechanism, such as email, SMS, WhatsApp, WeChat or other suitable delivery mechanism. One advantage of delivery via SMS is that SMS does not require an active Internet or data connection.

The method 800 also includes a step 806 of soliciting an email address if the user/listener chooses email as the preferred delivery mechanism. The method 800 also includes a step 808 of soliciting an application name if the user/listener chooses “Other” as the preferred delivery mechanism.

The method 800 also includes a step 810 of sending a registration code to the chosen delivery mechanism if the user/listener chooses SMS, WhatsApp or WeChat as the preferred delivery mechanism. The method 800 also includes a step 812 of soliciting from the user/listener the registration code that was just sent to the SMS, WhatsApp or WeChat delivery mechanism. The method 800 also includes a step 814 of validating the registration code.

If the registration code provided does not match the registration code sent (NO), the method 800 includes a step 816 of asking the user/listener for a next action, e.g., either re-enter the registration code (step 812) or send a new registration code (step 810). If the registration code provided matches the registration code sent (YES), the method 800 includes a step 818 of soliciting from the user/listener a default language in which to receive announcement broadcasts. The method 800 also includes a step 820 of saving all user/listener registration information in the user/listener data persistent data storage location or component 408 (FIG. 4).

According to an embodiment, a user/listener chooses one delivery mechanism. Alternatively, a user/listener chooses a plurality of delivery mechanisms, in which case steps 804 through 820 repeat for each chosen delivery mechanism. Alternatively, a user/listener chooses a priority order for the delivery mechanism. Also, according to an embodiment, a different language in which to receive announcement broadcasts may be specified for each delivery mechanism.

As discussed hereinabove, user/listener registration information is stored in the user/listener data persistent data storage location or component 408 (FIG. 4). For example, such data (and metadata) includes a user/listener information portion or section, a user/listener delivery portion of section, a user/listener station portion or section and a user/listener train, bus or airline portion or section.

The user/listener information portion or section includes, for example, a user/listener name, a user/listener password, a user/listener identification number, a default language and a user/listener status for each registered user/listener. The user/listener delivery portion or section includes, for example, the user/listener identification number, a delivery mechanism (e.g., SMS or email), a delivery detail (e.g., SMS number or email address), and an announcement broadcast delivery default language for each registered user/listener.

The user/listener transportation station portion or section includes, for example, the user/listener identification number, a transportation station identification number for each participating transportation station, an enabled/disabled status, and a transportation station announcement broadcast default language for each registered user/listener. The user/listener train, bus or airline portion or section includes, for example, the user/listener identification number, the train, bus or airline number, an enabled/disabled status, and a default language.

As an example, a user/listener with user identification number 20 requests delivery of each announcement broadcast via SMS and via email. Also, the user/listener with user identification number 20 requests delivery of all transportation station announcement broadcasts to the transportation station with a station identification of 1001 in French and the delivery of all transportation station announcement broadcasts to the transportation station with a station identification of 2002 in English.

Referring again to FIG. 4, as discussed hereinabove, the method 400 includes a step 416 of receiving an announcement broadcast from a transportation station. According to an embodiment, the annunciator system uses transportation station data 406 to determine the language of the announcement broadcast. Alternatively, natural language processing is used to determine the language of the announcement broadcast from the announcement broadcast itself. The announcement broadcast can be received as a text file containing the text of the announcement broadcast, or as an audio file containing the announcement broadcast message. When the announcement broadcast is received as an audio file, the speech of the announcement broadcast is converted to text and the converted text is saved in the announcement broadcast data persistent data storage location 418. When the announcement broadcast is received as a text file, the text is saved in the announcement broadcast data persistent data storage location 418.

According to an embodiment, the announcement broadcast data persistent data storage location 418 includes various data related to each announcement broadcast. For example, such data includes the transportation station identification number, an announcement broadcast identification number, the language of the announcement broadcast, the train, bus or airline number that is the subject of the particular announcement broadcast, and the actual text of the announcement broadcast (e.g., “the next train to Delhi is leaving from platform 9 at 10:17 am”). According to an embodiment, natural language processing can be used to extract or infer transportation information (such as the train, bus or airline number) from the text of the announcement broadcast.

The method 400 also includes a step 420 of processing each new announcement broadcast. For an announcement broadcast from the announcement broadcast data persistent data storage location 418, the processing step 420 searches the user/listener data persistent data storage location 408 for active users/listeners subscribed to receive announcement broadcasts from the transportation station from which the announcement broadcast originated. The processing step 420 also searches the user/listener data persistent data storage location 408 for active users/listeners subscribed to receive announcement broadcasts regarding the train, bus or airline mentioned in the announcement broadcast.

The processing step 420 also retrieves the requested language(s) for each active user/listener. For each active user/listener language, the processing step 420 converts the text of the announcement broadcast to the requested language, and saves the translated text message in the processed announcement broadcast data persistent data storage location or component 422.

According to an embodiment, the processed announcement broadcast data persistent data storage location or component 422 stores various data related to each announcement broadcast. For example, such data includes the transportation station identification number, an announcement broadcast identification number, the language of the announcement broadcast, the train, bus or airline number that is the subject of the particular announcement broadcast, and the text message of the announcement broadcast.

The method 400 also includes a step 424 of formulating each processed announcement broadcast for delivery, and saving the relevant information in a deliverable announcement broadcast data persistent data storage location or component 426. As discussed hereinabove, the formulating step 424 takes a new announcement broadcast from the announcement broadcast data persistent data storage location 418, and for each active user/listener from the user/listener data persistent data storage location 408 who requests announcement broadcasts from the particular transportation station mentioned in the announcement broadcast, selects the corresponding translated announcement broadcast from the processed announcement broadcast data persistent data storage location or component 422, and creates a corresponding entry in the deliverable announcement broadcast data persistent data storage location or component 426.

According to an embodiment, the deliverable announcement broadcast data persistent data storage location or component 426 has stored therein various data related to each processed announcement broadcast. For example, such data includes the transportation station identification number, an announcement broadcast identification number, the language of the announcement broadcast, the user/listener identification number, the delivery mechanism for the relevant user/listener, the status of the delivered announcement broadcast, and a retry count. The status can include one of a number of states, e.g., pending (at least one attempt has been made to deliver the announcement broadcast message), fail (at least one attempt has been made to deliver the announcement broadcast message and the attempt did not succeed), sent (at least one attempt has been made to deliver the announcement broadcast message and no response has yet been received), went offline (at least one attempt has been made to deliver the announcement broadcast message but the user/listener has been deactivated from active to registered/inactive) or delivered (the announcement broadcast message was successfully delivered to the user/listener). For each new entry, the status is set to “pending” and the retry count is set to “0.”

As discussed hereinabove, the method 400 includes a step 428 of delivering, for each entry in the deliverable announcement broadcast data persistent data storage location or component 426, the translated announcement broadcast to a mobile device 430 of each active registered user/listener from the user/listener data persistent data storage location 408.

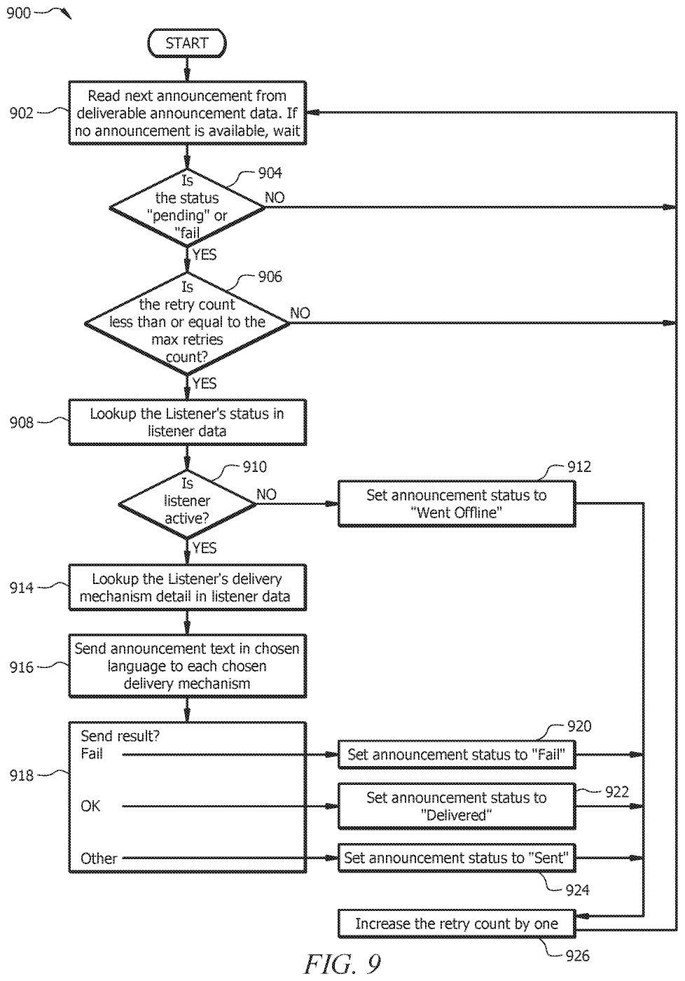

FIG. 9 is a flow diagram of a method 900 for a user/listener reading an announcement delivered by the annunciator system of FIG. 1, according to an embodiment. The method 900 includes a step 902 of a user/listener reading, via the mobile device 430 of the user/listener, a next announcement broadcast from the deliverable announcement broadcast data persistent data storage location or component 426. If no announcement broadcast is available, the mobile device 430 of the user/listener waits until an announcement broadcast appears.

The method 900 also includes a step 904 of determining if the status of the announcement broadcast is “pending” or “fail.” If the status of the announcement broadcast is neither “pending” nor “fail” (NO), the method 900 returns to the step 902 of reading the next announcement broadcast. If the status of the announcement broadcast is either “pending” or “fail” (YES), the method 900 continues to a step 906 of determining if the retry count for the announcement broadcast is less than or equal to a configurable max_retries_count. If the retry count for the announcement broadcast is not less than or equal to the configurable max_retries_count (NO), the method 900 returns to the step 902 of reading the next announcement broadcast. If the retry count for the announcement broadcast is less than or equal to the configurable max_retries_count (YES), the method 900 continues to a step 908 of looking up and retrieving the user/listener registration information from the user/listener data persistent data storage location or component 408.

The method 900 also includes a step 910 of determining from the retrieved user/listener registration information if the user/listener is active. If the step 910 determines from the retrieved user/listener registration information that the user/listener is not active (NO), the method 900 continues to a step 912 of setting the announcement broadcast status of the user/listener to “went offline.” If the step 910 determines from the retrieved user/listener registration information that the user/listener is active (YES), the method 900 continues to a step 914 of looking up and retrieving the delivery mechanism detail of the user/listener from the user/listener data persistent data storage location or component 408.

The method 900 also includes a step 916 of retrieving the language-specific text of the processed announcement broadcast from the processed announcement broadcast data persistent data storage location or component 422 and sending or delivering the retrieved language-specific text of the processed announcement broadcast to each listener device 106 (FIG. 1) of the user/listener, e.g., to the mobile device 430 of the user/listener. According to an embodiment, the user/listener may have a plurality of listener devices 106, with a delivery mechanism setting for each listener device 106. For example, each delivery mechanism setting can request a different language for the text of the announcement broadcast for the corresponding listener device 106.

According to an embodiment, if the listener device 106 of the user/listener is a smart phone, data hot links for the origin city, the destination city and the train, bus or airline number can be created within the text of the announcement broadcast message. The data hot links are used to provide additional information about the origin city, the destination city and the specific train, bus or airline. Also, according to an embodiment, the specific train, bus or airline number can activate a local navigation application on the smart phone of the user/listener to show directions to the arrival or departure platform of the specific train, bus or airline.

According to an alternative embodiment, if the listener device 106 of the user/listener is a smart phone, the delivery of the announcement broadcast message triggers a text-to-speech conversion in which the announcement broadcast message is delivered aurally. This delivery mechanism benefits user/listeners who are visually impaired.

The method 900 includes a step 918 of checking the result of sending or delivering the retrieved language-specific text of the processed announcement broadcast to each listener device 106. If the delivery result is “fail,” the method 900 continues to a step 920 of setting the announcement status in the deliverable announcement broadcast data persistent data storage location or component 426 to “fail.” If the delivery result is “OK,” the method 900 continues to a step 922 of setting the announcement status in the deliverable announcement broadcast data persistent data storage location or component 426 to “delivered.” Otherwise, the method 900 continues to a step 924 of setting the announcement status in the deliverable announcement broadcast data persistent data storage location or component 426 to “sent.”

Following the execution of step 912, step 920, step 922 or step 924, the method 900 continues to a step 926 of increasing the retry count by 1 in the deliverable announcement broadcast data persistent data storage location or component 426. After the execution of step 926, the method 900 returns to the step 902 of reading the next announcement broadcast from the deliverable announcement broadcast data persistent data storage location or component 426.

According to an embodiment, announcement broadcast messages are delivered only to registered users/listeners who are in an active state 514 (FIG. 5) and who are located inside or near the transportation station where the announcement broadcast occurs. Alternatively, announcement broadcast messages are delivered to registered and active users/listeners who are at any geographic location.

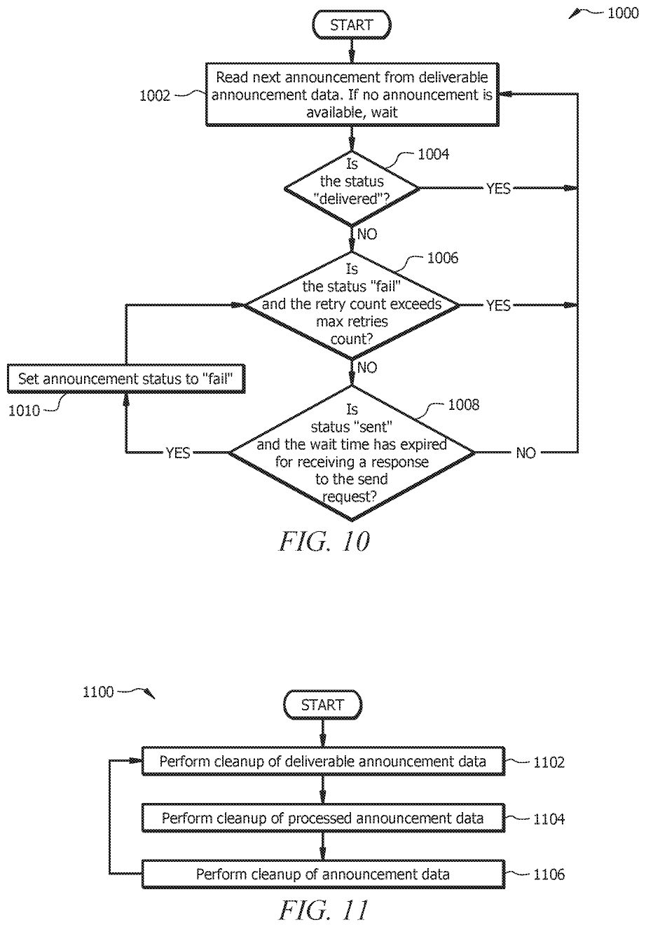

As discussed hereinabove, the method 400 includes a step 432 of monitoring, for each entry in the deliverable announcement broadcast data persistent data storage location or component 426, the success or failure of the delivery of the announcement broadcast. FIG. 10 is a flow diagram of a method 1000 for a user/listener monitoring an announcement delivered by the annunciator system of FIG. 1, according to an embodiment.

The method 1000 includes a step 1002 of reading a next announcement broadcast from the deliverable announcement broadcast data persistent data storage location or component 426. If no announcement broadcast is available, the reading step 1002 waits until an announcement broadcast appears.

The method 1000 also includes a step 1004 of determining if the status of the read announcement broadcast is “delivered.” If the status of the announcement broadcast is “delivered” (YES), the method 1000 returns to the reading step 1002 to read a next announcement broadcast. If the status of the announcement broadcast is not “delivered” (NO), the method 1000 continues to a step 1006 of determining if the status of the announcement broadcast is “fail” and if the retry count exceeds the configurable max_retries_count.

If the status of the announcement broadcast is “fail” and the retry count exceeds the configurable max_retries_count (YES), the method 1000 returns to the reading step 1002 to read a next announcement broadcast. If the status of the announcement broadcast is not “fail” and the retry count does not exceed the configurable max_retries_count (NO), the method 1000 continues to a step 1008 of determining if the status of the read announcement broadcast is “sent” and the configurable wait time has expired for receiving a response to the send request performed in step 916 (FIG. 9).

If the status of the announcement broadcast is “sent” and the configurable wait time has expired for receiving a response to the send request performed in step 916 (YES), the method 1000 continues to a step 1010 of setting the status of the announcement broadcast in the deliverable announcement broadcast data persistent data storage location or component 426 to “fail.” The method 1000 then returns to the step 1006 of determining if the status of the read announcement broadcast is “fail” and the retry count exceeds the configurable max_retries_count. If the status of the announcement broadcast is not “sent” and the configurable wait time has not expired for receiving a response to the send request performed in step 916 (YES), the method 1000 returns to the reading step 1002 to read a next announcement broadcast.

As discussed hereinabove, the method 400 includes a step 436 of cleaning up the announcement broadcast information/data stored in the announcement broadcast data persistent data storage location 418, the processed announcement broadcast data persistent data storage location or component 422 and the deliverable announcement broadcast data persistent data storage location or component 426 for each announcement broadcast that has been delivered to the appropriate active user/listener. According to an embodiment, announcement broadcasts are retained for a configurable amount of time. Alternatively, announcement broadcasts, e.g., the most recent live announcement broadcasts, are re-delivered to the appropriate active user/listener. The configurable max_redeliver_count determines how many announcement broadcasts are retained.

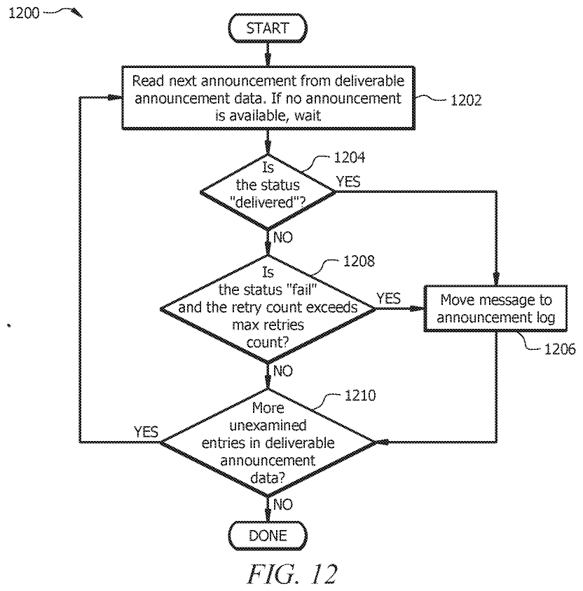

FIG. 11 is a flow diagram of a method 1100 for processing announcement stores in the annunciator system of FIG. 1, according to an embodiment. The method 1100 includes an initial step 1102 of cleaning up the deliverable announcement broadcast data persistent data storage location or component 426. The method 1100 also includes a step 1104 of then cleaning up the processed announcement broadcast data persistent data storage location or component 422. The method 1100 also includes a step 1106 of then cleaning up the announcement broadcast information/data stored in the announcement broadcast data persistent data storage location 418. The steps 1102, 1104 and 1106 are performed in this specific order to preserve the integrity of the announcement broadcasts and to prevent the deletion of an announcement broadcast before it is entirely processed.

FIG. 12 is a flow diagram of a method 1200 for cleaning up the deliverable announcement broadcast data persistent data storage location or component 426, according to an embodiment. The method 1200 includes a step 1202 of reading a next announcement broadcast from the deliverable announcement broadcast data persistent data storage location or component 426. If no announcement broadcast is available, the reading step 1202 waits until an announcement broadcast appears.

The method 1200 also includes a step 1204 of determining if the status of the read announcement broadcast is “delivered.” If the status of the announcement broadcast is “delivered” (YES), the method 1200 continues to a step 1206 of moving the announcement broadcast to the announcement log 434 (FIG. 4). If the status of the announcement broadcast is not “delivered” (NO), the method 1200 continues to a step 1208 of determining if the status of the announcement broadcast is “fail” and if the retry count exceeds the configurable max_retries_count.

If the status of the announcement broadcast is “fail” and the retry count exceeds the configurable max_retries_count (YES), the method 1200 continues to the step 1206 of moving the announcement broadcast to the announcement log 434. If the status of the announcement broadcast is not “fail” and the retry count does not exceed the configurable max_retries_count (NO), the method 1200 continues to a step 1210 of determining if there are more unexamined entries in the deliverable announcement broadcast data persistent data storage location or component 426. The method 1200 also continues to the determining step 1210 after the step 1206 of moving an announcement broadcast to the announcement log 434.

At step 1210, if there are more unexamined entries in the deliverable announcement broadcast data persistent data storage location or component 426 (YES), the method 1200 returns to the step 1202 of reading the next announcement broadcast from the deliverable announcement broadcast data persistent data storage location or component 426. If there are no more unexamined entries in the deliverable announcement broadcast data persistent data storage location or component 426 (NO), the method 1200 is complete.

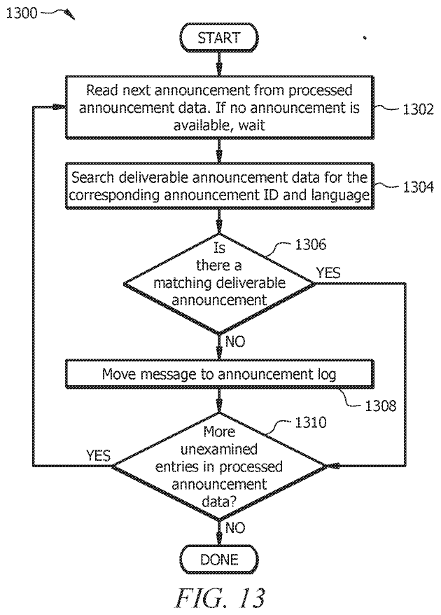

FIG. 13 is a flow diagram of a method 1300 for cleaning up the processed announcement broadcast data persistent data storage location or component 422, according to an embodiment. The method 1300 includes a step 1302 of reading a next announcement broadcast from the processed announcement broadcast data persistent data storage location or component 422. If no announcement broadcast is available, the reading step 1302 waits until an announcement broadcast appears.

The method 1300 also includes a step 1304 of searching the deliverable announcement broadcast data persistent data storage location or component 426 for an entry whose announcement broadcast identification and language match the entry from the processed announcement broadcast data persistent data storage location or component 422. The method 1300 also includes a step 1306 of determining if there is an entry in the deliverable announcement broadcast data persistent data storage location or component 426 whose announcement broadcast identification and language match the entry from the processed announcement broadcast data persistent data storage location or component 422.

At step 1306, if there is an entry in the deliverable announcement broadcast data persistent data storage location or component 426 whose announcement broadcast identification and language match the entry from the processed announcement broadcast data persistent data storage location or component 422 (YES), the method 1300 continues to a step 1310 of determining whether a next announcement broadcast from the deliverable announcement broadcast data persistent data storage location or component 426 exists.

At step 1306, if there is not an entry in the deliverable announcement broadcast data persistent data storage location or component 426 whose announcement broadcast identification and language match the entry from the processed announcement broadcast data persistent data storage location or component 422 (NO), the method 1300 continues to a step 1308 of moving the announcement broadcast to the announcement log 434 (FIG. 4).

The method 1300 also includes a step 1310 of determining if there are more unexamined entries in the deliverable announcement broadcast data persistent data storage location or component 426. The method 1300 also continues to the determining step 1310 from step 1306 if, at step 1306, it is determined that there is an entry in the deliverable announcement broadcast data persistent data storage location or component 426 whose announcement broadcast identification and language match the entry from the processed announcement broadcast data persistent data storage location or component 422 (YES).

At step 1310, if there are more unexamined entries in the deliverable announcement broadcast data persistent data storage location or component 426 (YES), the method 1300 returns to the step 1302 of reading the next announcement broadcast from the deliverable announcement broadcast data persistent data storage location or component 426. If there are no more unexamined entries in the deliverable announcement broadcast data persistent data storage location or component 426 (NO), the method 1300 is complete.

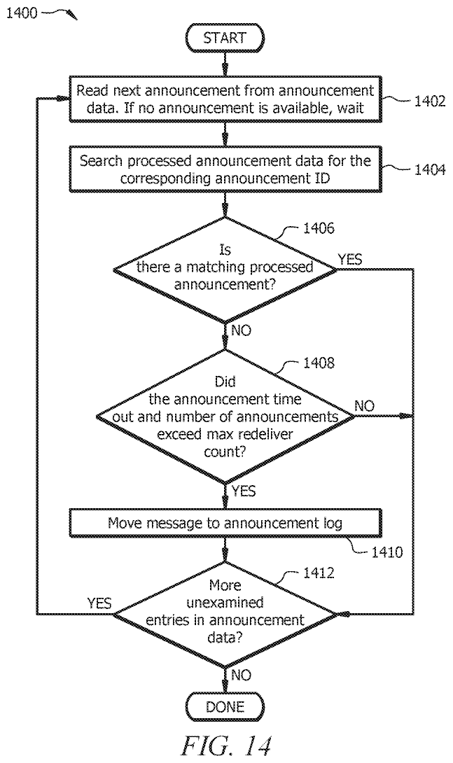

FIG. 14 is a flow diagram of a method 1400 for cleaning up the announcement broadcast information/data stored in the announcement broadcast data persistent data storage location 418, according to an embodiment. The method 1400 includes a step 1402 of reading a next announcement broadcast from the announcement broadcast data persistent data storage location 418. If no announcement broadcast is available, the reading step 1402 waits until an announcement broadcast appears.

The method 1400 also includes a step 1404 of searching the processed announcement broadcast data persistent data storage location or component 422 for an entry whose announcement broadcast identification matches an entry from the announcement broadcast data persistent data storage location 418. The method 1400 also includes a step 1406 of determining if there is an entry in the processed announcement broadcast data persistent data storage location or component 422 whose announcement broadcast identification matches an entry from the announcement broadcast data persistent data storage location 418.

At step 1406, if there is an entry in the processed announcement broadcast data persistent data storage location or component 422 whose announcement broadcast identification matches an entry from the announcement broadcast data persistent data storage location 418 (YES), the method 1400 continues to a step 1412 of determining whether a next announcement broadcast from the announcement broadcast data persistent data storage location 418 exists.

At step 1406, if there is not an entry in the processed announcement broadcast data persistent data storage location or component 422 whose announcement broadcast identification matches an entry from the announcement broadcast data persistent data storage location 418 (NO), the method 1400 continues to a step 1408 of determining if the announcement broadcast has timed out (i.e., if the difference in time between the current time and timestamp of the announcement broadcast exceeds a configurable min_retention_time value) and if the number of announcement broadcasts in the announcement broadcast data persistent data storage location 418 exceeds a configurable max_redeliver_count value.

At step 1408, if the announcement broadcast has timed out and if the number of announcement broadcasts in the announcement broadcast data persistent data storage location 418 exceeds a configurable max_redeliver_count value (YES), the method 1400 continues to a step 1410 of moving the announcement broadcast to the announcement log 434 (FIG. 4).

The method 1400 also includes a step 1412 of determining if there are more unexamined entries in the announcement broadcast data persistent data storage location 418. The method 1400 also continues to the determining step 1412 from step 1408 if, at step 1408, it is determined that the announcement broadcast has not timed out and if the number of announcement broadcasts in the announcement broadcast data persistent data storage location 418 does not exceed a configurable max_redeliver_count value (NO). The method 1400 also continues to the determining step 1412 from step 1406 if, at step 1406, it is determined that there exists a matching processed announcement in the announcement broadcast data persistent data storage location 418 (YES).

At step 1412, if there are more unexamined entries in the announcement broadcast data persistent data storage location 418 (YES), the method 1400 returns to the step 1402 of reading the next announcement broadcast from the announcement broadcast data persistent data storage location 418. If there are no more unexamined entries in the announcement broadcast data persistent data storage location 418 (NO), the method 1400 is complete.

According to an embodiment, the annunciator system 100 has various use cases that include a combination of functions that involve micro services for the following: publishing an audio message, converting the speech of the audio message to text, translating the text from generic text to different languages, sending email notifications and sending text and other application notifications. The annunciator system 100 also involves various scenarios. For example, users/listeners willing to get notifications as text register with the annunciator system. The transportation station operator announces various information related to transportation arrivals/departures/delays for the transportation station. The notification recorded at the transportation station is pushed to the annunciator system. The users/listeners registered with the annunciator system receive a text notification (in their preferred language) of the announcement broadcast for the transportation station to which the users/listeners have subscribed.

According to an embodiment of the invention, the annunciator system 100 has three layers: an application layer, an API (application program interface) layer, and a database layer. The application layer includes a user interface (UI) that provides a mechanism for a user/listener to subscribe to or register with the annunciator system. According to an embodiment, the application layer is coupled to the existing audio announcement system of the participating transportation station, so that recorded announcement broadcasts made at the transportation station are pushed to the database of the annunciator system.

The API layer includes or hosts the micro service based API functions used by the annunciator system. For example, the API layer includes a Notification Push function, a Speech-to-Text function, a Translate Text function, a Get Notification function and a Mail function.

The API functions serve four basis purposes. The first function is to upload announcement broadcast audio recordings to the annunciator system database. The second function involves processing the audio file to describe how the audio file available in the annunciator system database is to be converted to generic text by a speech-to-text API. The third function involves processing the generic text to retrieve the transportation number (e.g., the train, bus or airline number) and store the generic text and the transportation number in the annunciator system database. The fourth function involves translating the generic text to various languages based on the preferences of the user/listener and sending the translated notification to the user/listener.

The database layer stores raw audio files, processed text, translated text and user/listener information.

According to an embodiment, the annunciator system generates a subscription user interface (UI) page on the mobile device of the user/listener to allow the user/listener to subscribe to or register with the annunciator system.

The annunciator system also generates a UI page that is used to upload transportation station audio notifications. This UI page mimics the audio notification system of the transportation station in which transportation station agents announce notifications. This UI page allows a user/listener to browse audio notification files and select the transportation station from which the announcement broadcast is made. This UI page also allows the user/listener to select a specific notification, which then is uploaded and displayed on the mobile device of the user/listener.

Once the audio file is uploaded successfully, the speech-to-text API of the annunciator system converts the audio message to generic text and retrieves the train, bus or airline number. The annunciator system then scans subscriber data to retrieve all subscribers who are to receive the announcement broadcast that was just processed. The annunciator system then translates the generic text of the announcement broadcast to the preferred language of the user/listener, and sends the text notification to the mobile device of the user/listener.

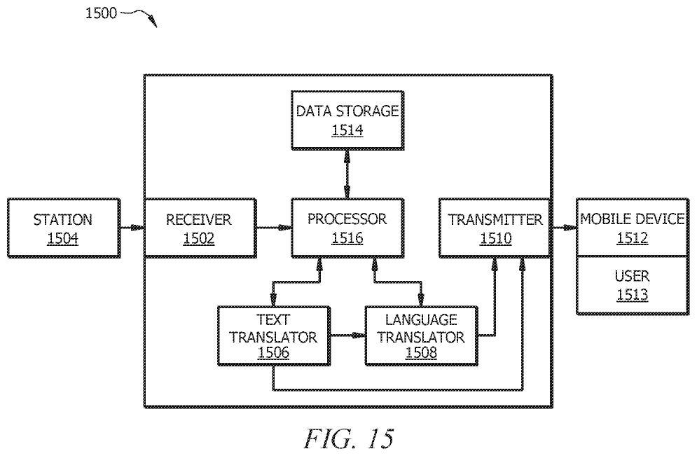

FIG. 15 is a schematic view of an annunciator system 1500, according to an embodiment. The annunciator system 1500 includes one or more receivers 1502 for receiving announcement broadcasts from one or more transportation stations 1504. The receiver 1502 receives announcement broadcasts in the form of audio files or text files, as discussed hereinabove.

The annunciator system 1500 also includes a text translator 1506 (e.g., a speech to text translator) for translating announcement broadcast audio files, received by the receiver 1502, into text files, as discussed hereinabove. The annunciator system 1500 also includes a language translator 1508 for translating announcement broadcast text files, received by the receiver 1502, into one or more different languages, as discussed hereinabove. The annunciator system 1500 also includes one or more transmitters 1510 for transmitting translated text from the language translator 1508 to one or more mobile devices 1512 of one or more users/listeners 1513, as discussed hereinabove.

The annunciator system 1500 also includes at least one data storage component 1514. The data storage component 1514 includes or is coupled to one or more of the station data persistent data storage location or component 406, the user/listener data persistent data storage location or component 408, the announcement broadcast data persistent data storage location or component 418, the processed announcement broadcast data persistent data storage location or component 422, the deliverable announcement broadcast data persistent data storage location or component 426 and the announcement log 434, as discussed hereinabove.

The annunciator system 1500 also at least one processor 1516. The processor 1516 is coupled to the receiver 1502, the text translator 1506, the language translator 1508, the transmitter 1510 and the data storage component 1514. The processor 1516 processes instructions, data and other information received by the annunciator system 1500. The processor 1516 also manages the movement of various instructional and informational flows between various components within the annunciator system 1500.

It will be apparent to those skilled in the art that many changes and substitutions can be made to the embodiments described herein without departing from the spirit and scope of the disclosure as defined by the appended claims and their full scope of equivalents.

1. A method for delivering announcement broadcasts, the method comprising:
receiving by an annunciator system an audio announcement broadcast from an audio announcement broadcast system of a shared public space, wherein the audio announcement broadcast system is registered with the annunciator system;
interpreting the received audio announcement broadcast using natural language processing to extract announcement information;
storing the received audio announcement broadcast and the extracted announcement information in a data storage location coupled to the annunciator system;
translating the stored audio announcement broadcast into a text message; and
transmitting the text message to at least one mobile device of at least one user registered with the annunciator system, based on the announcement information and the user information stored in the data storage location, wherein the text message is transmitted to the mobile device independent of the geographic location of the mobile device relative to the geographic area serviced by the audio announcement broadcast system.

2. The method as recited in claim 1, wherein the audio announcement broadcast is received as an audio file, and wherein the method further comprises converting the audio file to a text file.

3. The method as recited in claim 1, wherein the audio announcement broadcast is received as an audio message, and wherein the method further comprises converting the speech of the audio announcement broadcast to a text file and storing the converted text file in the data storage location.

4. The method as recited in claim 1, wherein the audio announcement broadcast is received as a text file, and wherein the method further comprises storing the text file in the data storage location.

5. The method as recited in claim 1, further comprising translating the language of the text message into a chosen language of the user prior to transmitting the text message to the mobile device of the user.

6. The method as recited in claim 1, further comprising monitoring the success or failure of the transmission of the text message to the mobile device of the user.

7. The method as recited in claim 1, further comprising removing the stored audio announcement broadcast from the data storage location upon successful transmission of the text message to the mobile device of the user.

8. The method as recited in claim 1, further comprising registering the user with the shared public space automatically when the user is located within the shared public space.

9. The method as recited in claim 1, further comprising registering the user with the shared public space manually via the mobile device of the user.

10. The method as recited in claim 1, further comprising storing shared public space information and user information in the data storage location.

11. The method as recited in claim 1, wherein the audio announcement broadcast is broadcast from a broadcast system of a first shared public space and the user is located within a second shared public space.

12. The method as recited in claim 1, wherein the shared public space is one of a train station, a train, a bus station, a bus, an airport, an airplane, a passenger ship and a subway.

13. An announcement broadcast delivery system, comprising:
a processor;
a data storage component coupled to the processor, wherein the data storage component has announcement information and user information stored therein;
a receiver coupled to the processor for receiving an audio announcement broadcast from a broadcast system of a shared public space, wherein the broadcast system is registered with the announcement broadcast delivery system, wherein the processor stores the received audio announcement broadcast in the data storage component;
a text translator coupled to the processor for translating the received audio announcement broadcast into a text message; and
a transmitter coupled to the processor for transmitting the text message to at least one mobile device of at least one user registered with the announcement broadcast delivery system, based on the announcement information and the user information stored in the data storage component, wherein the transmitter transmits the text message to the mobile device independent of the geographic location of the mobile device relative to the geographic area serviced by the broadcast system.

14. The system as recited in claim 13, wherein the receiver receives the audio announcement broadcast as an audio file, and wherein the system further comprises a text converter coupled to the processor for converting the audio file to a text file.

15. The system as recited in claim 13, wherein the system further comprises a language translator for translating the language of the text message into a preferred language of the user prior to the transmitter transmitting the text message to the mobile device of the user.

16. The system as recited in claim 13, wherein the user automatically registers with the announcement broadcast delivery system when the user is located within the shared public space.

17. The system as recited in claim 13, wherein the user manually registers with the announcement broadcast delivery system via the mobile device of the user.

18. The system as recited in claim 13, wherein the processor monitors the success or failure of the transmission of the text message to the mobile device of the user.

19. The system as recited in claim 13, wherein the processor removes the stored announcement broadcast from the data storage component upon successful transmission of the text message to the mobile device of the user.

20. The system as recited in claim 13, wherein the audio announcement broadcast is broadcast from a broadcast system of a first shared public space and the user is located within a second shared public space.

21. The system as recited in claim 13, wherein the shared public space is one of a train station, a train, a bus station, a bus, an airport, an airplane, a passenger ship and a subway.
